(19) United States
(12) Patent Application Publication
(10) Pub. No.: US 2014/0021128 A1
(43) Pub. Date: Jan. 23, 2014

(54) MEMBRANE SUPPORTING STRUCTURE AND TUBULAR MEMBRANE

(71) Applicant: Cut Membranes Technologies Canada Inc., Hamilton (CA)

(72) Inventors: John Ionel TOMESCU, Ancaster (CA); Monica Alice TOMESCU, Ancaster (CA)

(21) Appl. No.: 13/945,032

(22) Filed: Jul. 18, 2013

Related U.S. Application Data
(60) Provisional application No. 61/674,542, filed on Jul. 23, 2012.

(51) Int. Cl. B01D 69/10; B01D 69/04; B01D 67/00; B01D 69/12

(52) U.S. Cl. CPC B01D 69/10; B01D 69/12; B01D 69/04; B01D 67/0002
USPC 210/497.01; 210/483; 210/499; 156/277; 156/60

(57) ABSTRACT

A membrane is made with a supporting structure having two or more layers. One layer is embedded in the membrane wall. Another layer generally abuts the membrane wall, preferably on the permeate side of the membrane wall. These two layers are preferably bonded together. The membrane may be, for example, a tubular membrane. Optionally, the membrane may be made of materials able to work at a temperature of 80 degrees C. or more.

### RELATED APPLICATION

This specification claims the benefit under 35 USC 119 of US provisional application number 61/674,542 filed on Jul. 23, 2012 which is incorporated by reference.

### FIELD

This specification relates to separation membranes, for example solid-liquid separation membranes.

### BACKGROUND

Separation membranes are often classified according to their filtration range, for example reverse osmosis (RO), nanofiltration (NF), microfiltration (MF) or ultrafiltration (UF). Membranes may also be classified according to their shape and materials. For example, some membranes are provided in the shape of a tube. Tubes with small diameters, for example with inside diameters in the range of about 0.2 to 2.5 mm, are typically called hollow fiber or capillary membranes. Tubes with larger diameters, for example with inside diameters in the range of about 3 mm to about 50 mm, are typically called tubular membranes. The larger diameter of tubular membranes facilitates processes that flow a viscous or highly fouling feed solution through the bores of the membranes, often with recirculation of the feed solution to provide higher velocity flow.

U.S. Pat. No. 6,077,376 describes an example of a tubular membrane made by winding a strip of a thermoplastic non-woven material on a mandrel to provide a tubular support member. The strip is wound under tension and heated with a hot air gun to smooth the fibers on the inside of the strip. Overlapping edges of the thermoplastic material are fused together by ultrasonic welding. An MF or UF membrane is formed on the inside of the support member by a casting bob pulled through the support member.

Regarding materials, polymeric membranes are generally considered to be relatively inexpensive, but subject to temperature, pressure and chemical limitations. Other materials, such as ceramics or metals, may be an order of magnitude more expensive than polymeric membranes but are able to withstand high temperatures and acidic or basic environments. Produced water, for example, has a temperature of about 90 degrees C. and a pH of about 9.5 to 11.5 and produced water membrane filtration trials generally use ceramic membranes.

### INTRODUCTION

The following introduction is intended to introduce the reader to the detailed description to follow and not to limit or define any claimed invention.

This specification describes a membrane and a method of manufacturing a membrane. The membrane is made with a supporting structure having two or more layers. The membrane may be, for example, a tubular membrane. Optionally, the membrane may be made of materials able to work at a temperature of up to 80 degrees C. or up to 90 degrees C. or higher.

One layer of the supporting structure is embedded in the membrane wall. Another layer generally abuts the permeate side of the membrane wall. These two layers are preferably bonded together. The membrane may have the capability of being backwashed.

A method of making a membrane is described in this specification in which a supporting structure is coated with dope. The supporting structure has a first layer attached to a second layer. Dope is applied to the first layer but passes through the first layer to be deposited on the second layer.

### BRIEF DESCRIPTION OF THE FIGURES

FIG. 1 is an isometric view of a tubular membrane

FIG. 2 is an isometric cross-sectional view of the tubular membrane of FIG. 1.

FIG. 3 is an exploded isometric cross-sectional view of the tubular membrane of FIG. 1.

FIG. 4 is an end view of a portion of the tubular membrane of FIG. 1.

FIG. 5 is an end view of a portion of a second tubular membrane.

FIG. 6 is an isometric view of a third tubular membrane.

### DETAILED DESCRIPTION

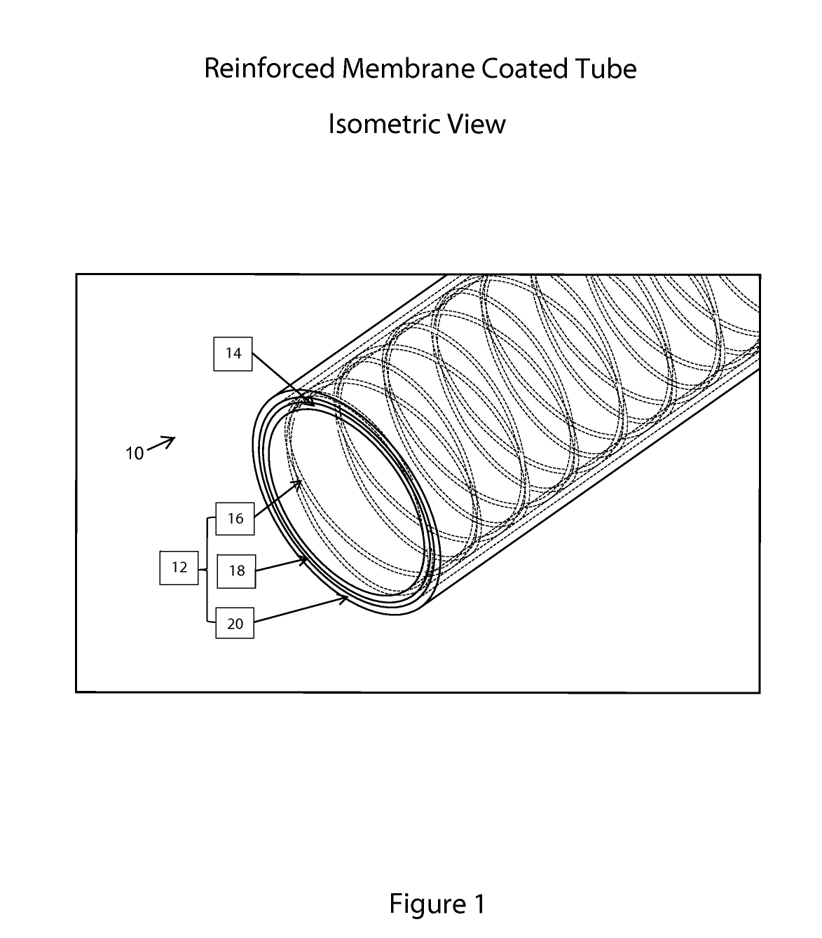

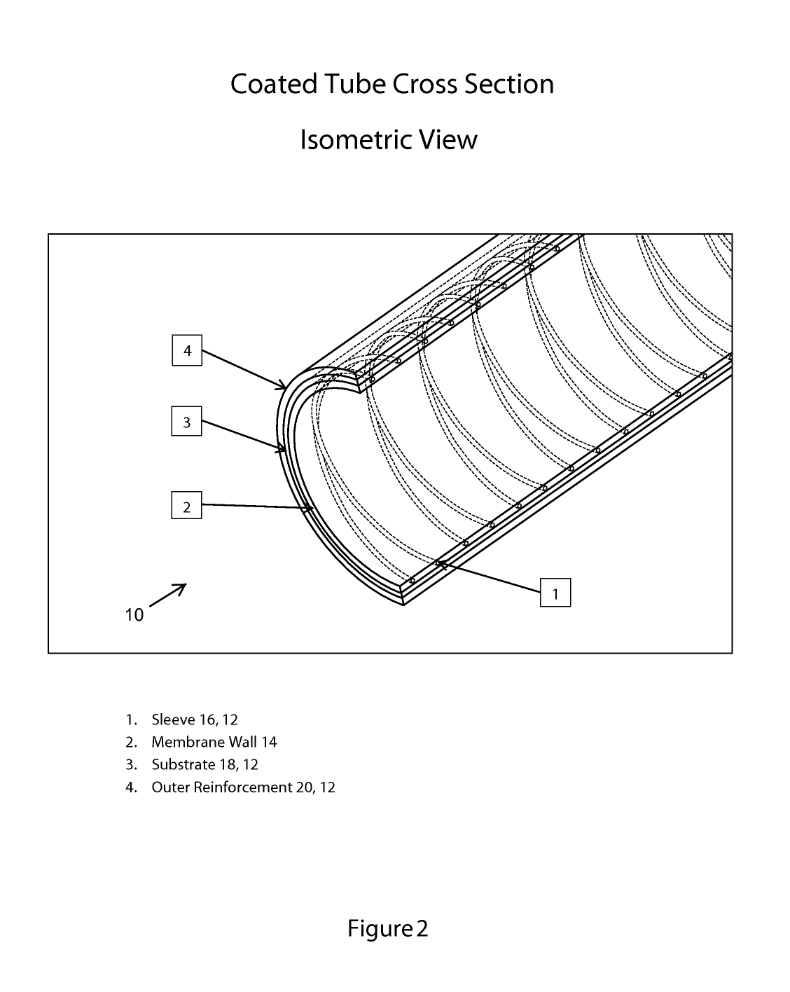

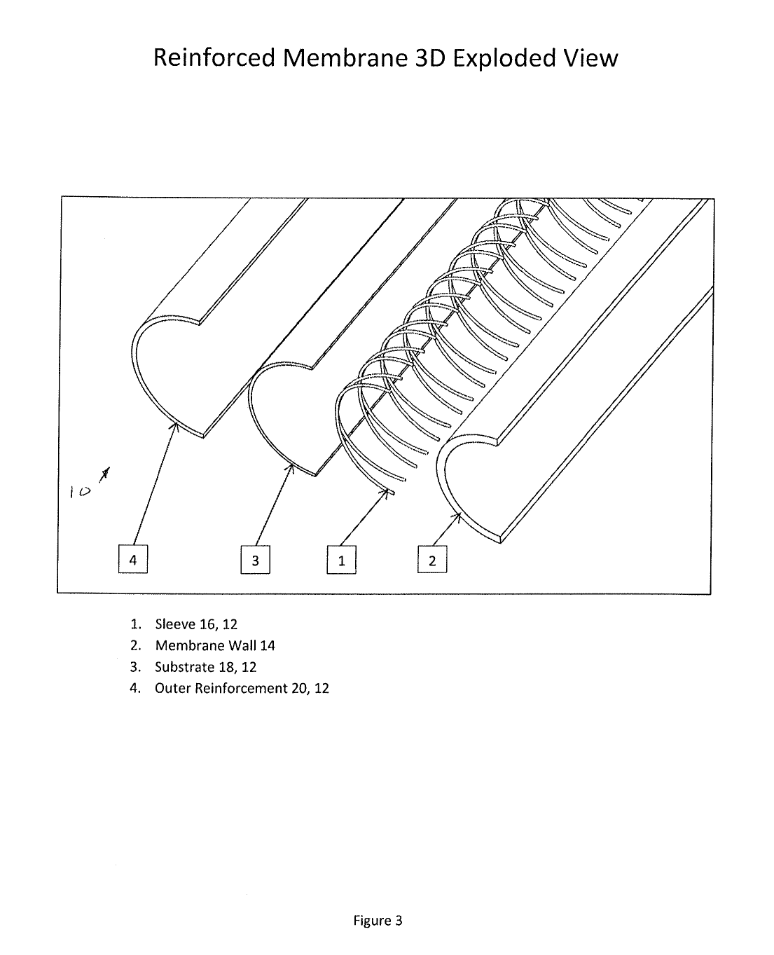

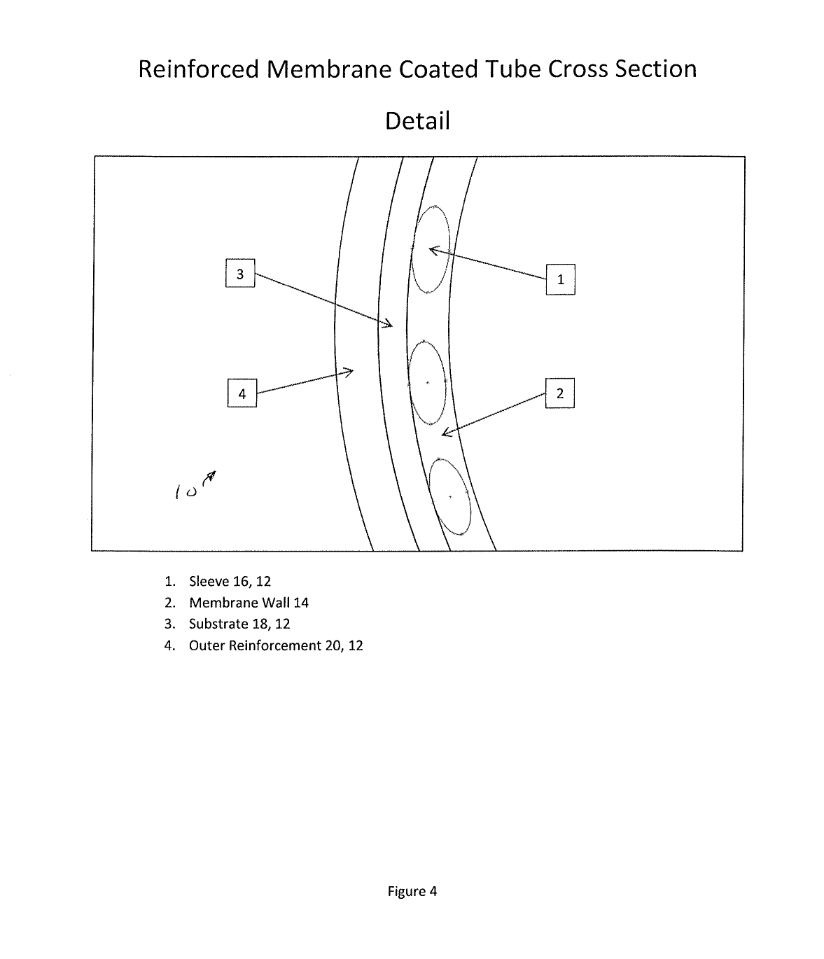

FIGS. 1 to 4 show a tubular membrane 10. The tubular membrane 10 has a supporting structure 12 comprising multiple layers. A membrane wall 14 is formed by coating a mixture of polymers dissolved in a solvent, alternatively called a dope, on the supporting structure 12. The supporting structure 12 includes a sleeve 16 and a substrate 18. Optionally, the supporting structure 12 may also include an outer reinforcement 20. In the tubular membrane 10, the sleeve 16 is located inside of and abuts the substrate 18, which is located inside of and abuts the outer reinforcement 20.

The sleeve 16 is a highly porous structure having openings, for example, of the area of a 1 mm diameter hole or more. The sleeve 16 may be made of continuous monofilament or multifilament yarns formed into a mesh-like structure. For example, the sleeve 16 may be made using a textile process such as weaving, braiding or knitting. Alternatively, the sleeve 16 may be made by wrapping one or more yarns in a spiral over one or more other yarns wrapped in a spiral in the other direction around a supporting tube generally in the manner of making plastic mesh or netting or RO feed spacer material. The yarns in the sleeve 16 may be bonded to each other or merely overlap each other. The yarns are made of one or more polymers such as polyethylene terephthalate (PET), poly(p-phenylene sulfide) (PPS), or polypropylene (PP). The sleeve may be from about 25 microns to about 200 microns thick.

The substrate 18 is porous but its openings are relatively small such that the dope may be coated on the substrate 18 at least without passing completely through the substrate 18. Preferably, the membrane wall 14 does not penetrate through more than half of the thickness of the substrate 18. For example, the substrate 18 may be a non-woven material, a very tight braid or a sintered polymer tube. In particular, a non-woven material, for example with a thickness between about 50 microns and 300 microns, may be wrapped around the sleeve 16 with varying degrees of overlap and in one or more layers. The non-woven material may comprise thermally bonded short fibers, optionally mixed with longer reinforcing fibers. Adjacent turns and layers of the wrapping are preferably attached to each other for example by an adhesive or thermal bonding. The substrate 18 is preferably made from a material having a high service temperature such as PPS.

Depending on the separation application and the tubular membrane diameter, an outer reinforcement 20 may optionally be added to the outside of the substrate 18. The outer reinforcement layer may be made of a yarn, for example fiberglass roving, soaked in a curable potting material, for example epoxy. The yarn is wrapped around the substrate 18 and then the potting material is cured or allowed to cure. The outer reinforcement 20 can also be woven or braided sheets or straps wrapped around the substrate (impregnated or not with thermoset epoxy systems). It can be made of polymer monofilament or yarns or carbon fiber, Kevlar or other high temperature, high strength materials. The outer reinforcement 20 increases the mechanical strength of the tubular membrane 10 and allows operation at higher pressures, for example up to 100 psi.

The membrane wall 14 is located on the inside of the substrate 18 and at least partially covers the sleeve 16. The membrane wall 14 also contacts the substrate 18. The yarns of the sleeve 16 are embedded in the membrane wall 14. The outer surface of the sleeve 16 is covered by the membrane wall 14 except at or near points where the sleeve 16 is bonded to the substrate 18. Preferably, the membrane wall is 25 to 200 microns thicker than the sleeve 16 and completely covers the sleeve 16 such that the sleeve 16 is encapsulated within the tubular membrane 10.

The membrane wall 14 is formed by solidifying a dope made from one or more base polymers, one or more solvents and, optionally, one or more non-solvents, pore forming agents or secondary polymers. After being solidified, the membrane wall is primarily made up of the base polymers. Suitable base polymers include polysulfone (PS or PSU), polyethersulfone (PES), PET, polyvinylidene fluoride (PVDF), PP and polyvinyl chloride (PVC). PS in particular is stable in boiling water and at temperatures up to 150 degrees C. The membrane wall 14 may be between about 50 microns and 400 microns thick measured at a pore in the sleeve 16.

The membrane wall 14 may have a smooth inner surface or skin. Alternatively, the membrane wall 14 may cover the sleeve 16 but have an undulating inner surface or skin corresponding to the pattern of the sleeve 16. In this way, turbulence may be created in the bore of the membrane 10 when feed water flows through it to inhibit fouling.

The membrane wall 14 is applied to the supporting structure 12 after at least the sleeve 16 and substrate 18 have been assembled together. The membrane wall 14 is made porous typically by a non-solvent induced phase separation (NIPS) or thermally induced phase separation (TIPS) process. The liquid dope may be applied to the supporting structure 12 by casting, for example with a casting knife or bob, or by dipping, deposition, spray or another method.

The membrane 10 is made using a mandrel as a temporary support. The mandrel may be made, for example, of a metal such as stainless steel, a ceramic or plastic. The sleeve 16 is pulled over the mandrel if the sleeve 16 was pre-made, or formed over the mandrel. If the sleeve 16 will be glued to the support 18, the adhesive may be applied to the outside of the sleeve 16 or to the inside of the substrate material 18 before it is wrapped over the sleeve 16. The adhesive does not create a continuous film and so does not act as a complete barrier to the flow of permeate. The adhesive may be applied, for example, by spraying it on the sleeve 16 or by applying parallel strips of adhesive or rows of adhesive beads on to the substrate 18 material by a roller or servo controlled printing head. Suitable adhesives include, for example, normal and reactive polyurethanes, two component epoxy systems, methyl methacrylate (MMA) adhesives, polyurethane (PUR) hot melt or other thermoplastic adhesives and other compositions.

Alternatively, the sleeve 16 may be attached to the substrate 18 by sonic welding or laser welding. In this case, the substrate 18 may be wrapped over the sleeve 16 without first applying an adhesive. However, a near infrared absorbing material such as Clearweld™ by Gentex Corporation may be added between the layers of the supporting structure 12 to enhance laser welding.

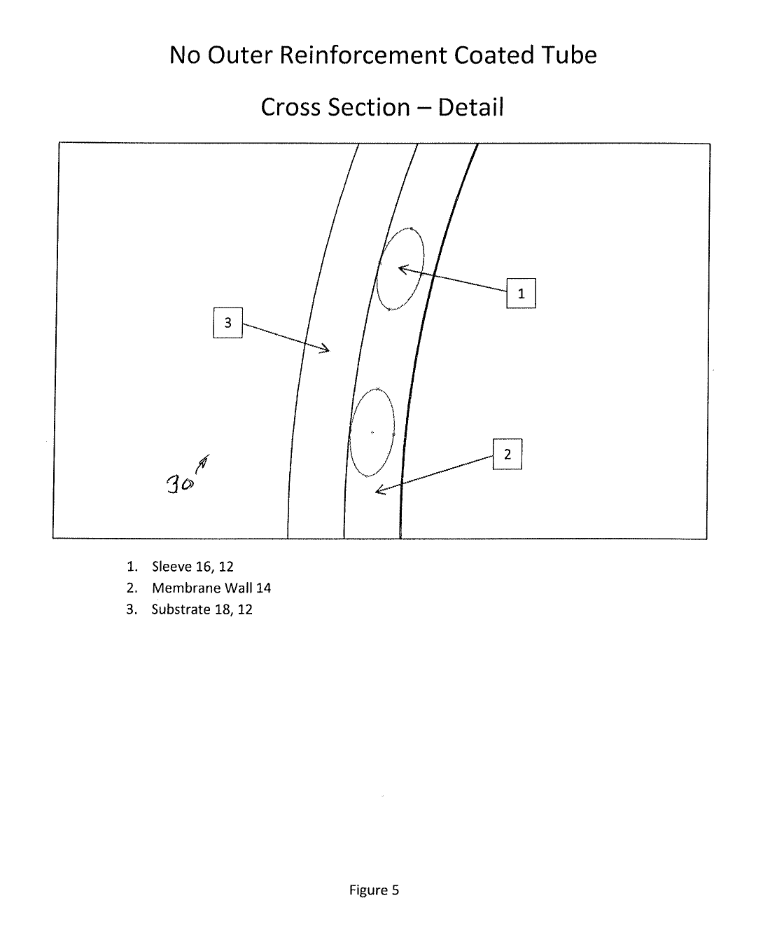

The outer reinforcement 20, if any, is applied over the substrate 18. As shown in FIG. 5, however, the outer reinforcement 20 is optional and a second tubular membrane 30 can be made as described for the tubular membrane 10 but without an outer reinforcement 20. Second tubular membrane 40 is useful, for example, for relatively lower pressure applications or with relatively lower diameter membranes.

The completed supporting structure 12 is removed from the mandrel either continuously as more supporting structure 12 is being made at the other end of the mandrel, or as a discrete segment. A dope is applied to the inside of the supporting structure 12 at a thickness sufficient to at least partially, and preferably completely, cover the sleeve 16. The dope also passes through the sleeve 16 to be deposited on the substrate 18. The dope is then coagulated, optionally after passing through an air gap, to form the membrane wall 14. The membrane wall 14 has an inner separation layer, for example in the UF or MF range.

After coagulation, the membrane 10 is typically post treated, rinsed, dried, tested and optionally impregnated with a pore preserving agent such as glycerin. The sleeve 16 reinforces the resulting membrane wall 14. Further, since the sleeve 16 is attached to the substrate 18, the sleeve 16 helps resist separation of the membrane wall 14 from the substrate 18. Optionally, a sufficient area of attachment between the sleeve 16 and substrate 18 may be provided such that the membrane 10 may be backwashed.

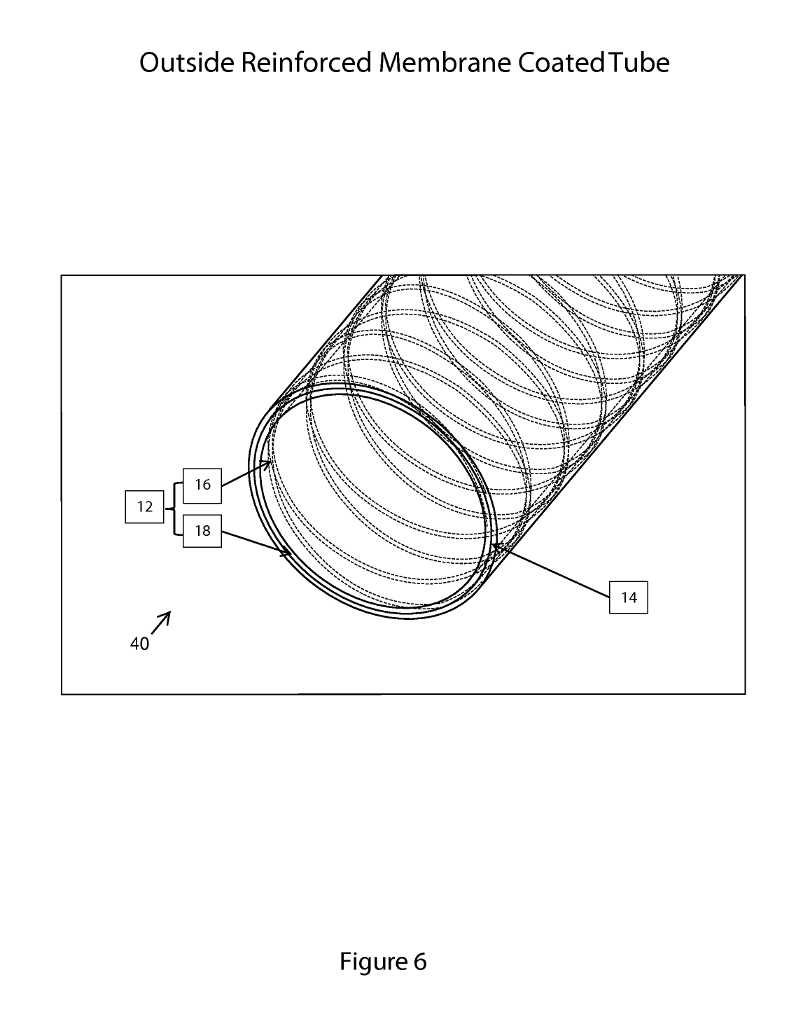

FIG. 6 shows a third tubular membrane 40. The third tubular membrane 40 is like the tubular membrane 10 but the sleeve 16 is outside of the substrate 18 and the membrane wall 14 is at the outside of the third tubular membrane 40. The third tubular membrane 40 is made by first forming the substrate 18 into a tubular shape, optionally over a mandrel. The substrate 18 may be formed of one or more spiral wrapped layers of a non-woven or other fabric bonded together for example by an adhesive, sonic or laser welding. The sleeve 16 is then pulled or formed over the tubular substrate 18. The sleeve 16 is attached to the tubular substrate 18 as described for the tubular membrane 10. This supporting structure 12 is then coated on its outer surface with a dope partially or completely covering the sleeve 16 and being deposited on the substrate 18. After coating, the dope is solidified, for example in a coagulation bath, to form the membrane wall 14.

The tubular membranes 10, 30, 40 may be potted into the shell to make a membrane module. The shell may be made of a high temperature polymer such as PPS. The tubular membranes 10, 30, 40 may be potted in the shell with a high temperature thermoset potting material such as an epoxy cured at a high temperature. Another high temperature thermoset potting material is described in U.S. Pat. No. 6,709,494. In one example, 75 parts by weight of Epon™ 160 (phenol formaldehyde novolac polyglycidl ether) available commercially from Shell was mixed with 25 parts by weight of MY0501™ (4-glycidyloxy-N,N-diglycidyl aniline) available commercially from Vantico. The resin blend was mixed with a hardener comprising cycloaliphatic and aromatic amines and cured at 175 degrees C. The cured resin was durable in a hollow fiber membrane module at temperatures up to 107 degrees C. Some of the membrane wall 14 may melt if the potting material is cured at a temperature over the melting temperature of the membrane wall polymers. However, such melting at or near where the tubular membranes 10, 30, 40 are sealed in the potting material does not effect most of the permeating area of the tubular membranes 10, 30, 40.

Attaching the layers of the supporting structure 12, for example sleeve 16 and substrate 18, interferes with some permeate flow. However, this attachment resists delamination of the membrane wall from the substrate. Sufficient bonding between the layers of the supporting structure allows the membrane to be backwashed.

The tubular membranes 10, 30, 40 may have an inner diameter in the range of about 3 mm to about 50 mm. The tubular membrane 10, 30, 40 can be formed in a batch process in lengths ranging from, for example, about 0.1 meters to about 10 meters. Optionally, the supporting structure 12 or the entire tubular membrane 10, 30, 40 can be formed in a continuous process and cut to a desired length after being formed.

The resulting membrane is useful, for example, for solid liquid separation. Optionally, the membrane may be able to work at elevated temperatures, for example up to 80 degrees C. or up to 90 degrees C., optionally with the ability to operate for short periods of time at up to 95 degrees C. Optionally, the membrane may be useful at pressures up to 100 PSI. Although this description has concentrated on tubular membranes, the membrane structure and method of manufacture described herein may also be used to create a flat sheet membrane.

### LIST OF ELEMENTS

10 Tubular membrane

12 Supporting structure

14 Membrane wall

16 Sleeve

18 Substrate 18

20 Outer reinforcement

30 Second tubular membrane

40 Third tubular membrane

1. A membrane comprising,
a) a supporting structure, the supporting structure comprising (i) a first layer, and (ii) a second layer attached to the first layer; and,
b) a membrane wall attached to the supporting structure, wherein,
c) the first layer is embedded in the membrane wall; and,
d) the membrane wall is attached to the inner or outer surface of the second layer.

2. The membrane of claim 1 wherein the supporting structure is in the shape of a tube.

3. The membrane of claim 1 wherein the first layer and the second layer attached with an adhesive or by sonic or laser welding.

4. The membrane of claim 3 wherein the first layer is attached to the second layer by an adhesive selected from the group of: normal and reactive polyurethanes, two component epoxy systems, methyl methacrylate (MMA) adhesives and polyurethane (PUR) hot melt.

5. The membrane of claim 3 wherein the first layer is attached to the second layer by sonic welding or laser welding after a near infrared absorbing material is added between the first layer and the second layer.

6. The membrane of claim 1 further comprising an outer reinforcement.

7. The membrane of claim 1 wherein the first layer has openings of the area of a 1 mm diameter hole or more.

8. The membrane of claim 1 wherein the first layer is made of continuous monofilament or multifilament yarns formed into a mesh-like structure.

9. The membrane of claim 8 wherein the yarns are made of one or more polymers selected from the group of: polyethylene terephthalate (PET), poly(p-phenylene sulfide) (PPS), and polypropylene (PP).

10. The membrane of claim 1 wherein the second layer comprises a non-woven material comprising thermally bonded short fibers mixed with longer reinforcing fibers.

11. The membrane of claim 1 wherein the second layer comprises poly(p-phenylene sulfide) (PPS) fibers.

12. The membrane of claim 1 wherein the membrane wall is 25 to 200 microns thicker than the first layer and encapsulates the first layer.

13. The membrane of claim 1 wherein the membrane wall comprises polysulfone.

14. The membrane of claim 1 wherein the membrane wall has an undulating skin.

15. The membrane of claim 1 potted into a shell to make a membrane module wherein the shell is made of poly(p-phenylene sulfide) and the potting material is an epoxy usable at temperatures of 80 degrees C. or more.

16. The membrane of claim 1 wherein all materials in the membrane are usable at temperatures of 80 degrees C. or more.

17. A method of making a membrane comprising the steps of,
a) forming a supporting structure comprising a first layer attached to a second layer;
b) coating dope on the first layer of the supporting structure such that the dope passes through the first layer and is deposited on the second layer; and,
c) solidifying the dope.

18. The method of claim 17 wherein the supporting structure is in the shape of a tube.

19. The method of claim 17 wherein step a) comprises forming the supporting structure over a mandrel.

20. The method of claim 17 wherein step a) comprised placing an adhesive or a near infrared absorbing material on the first layer and the second layer by spraying or by applying parallel strips of adhesive or rows of adhesive beads on to the first layer or the second layer by a roller or servo controlled printing head.
